(19) United States
(12) Patent Application Publication
(10) Pub. No.: US 2002/0050823 A1
(43) Pub. Date: May 2, 2002

(54) IGNITING SYSTEM WITH A DEVICE FOR MEASURING THE ION CURRENT

(76) Inventors: LOTHAR PUETTMANN, WEISSACH (DE); WALTER GOLLIN, SACHSENHEIM (DE); BERNHARD EISELE, DITZINGEN (DE); MARKUS KETTERER, STUTTGART (DE); HUBERT BISCHOF, VAIHINGEN/ENZ (DE)

Correspondence Address: KENYON & KENYON, ONE BROADWAY, NEW YORK, NY, 10004, US

(21) Appl. No.: 09/319,060

(22) PCT Filed: Sep. 26, 1997
(86) PCT No.: PCT/DE97/02198

(30) Foreign Application Priority Data
Nov. 28, 1996 (DE) 196 49 278.5

(51) Int. Cl. F02P 17/00

(52) U.S. Cl. 324/388

(57) ABSTRACT

The invention relates to an inductive ignition apparatus for a combustion engine, having a measurement device for ascertaining the ionization current at the spark plug of each cylinder, and having for each spark plug an ignition coil device which forms the ignition high voltage, operates on the transformer principle, and has a primary and a secondary winding, and through whose secondary winding the ionization current flows. According to the present invention, a switch (S1) is provided which short-circuits the primary winding (L1) for the duration of the ionization current measurement.

### BACKGROUND INFORMATION

The present invention relates to an inductive ignition apparatus for a combustion engine, having a measurement device for ascertaining the ionization current at the spark plug of each cylinder, and having for each spark plug an ignition coil device which forms the ignition high voltage, operates on the transformer principle, and has a primary and a secondary winding, and through whose secondary winding the ionization current flows.

Accurate diagnostic systems which allow conclusions to be drawn as to the combustion process are necessary in order to operate combustion engines at high efficiency and to meet stringent requirements in the area of on-board diagnosis. These diagnostic systems should moreover preferably be economical. It is known to take important information about the progress of combustion directly from the combustion chamber of a combustion engine (internal combustion engine). This is done by so-called ionization current measurement, in which during a combustion cycle, the spark plug first performs its actual task, i.e. igniting the combustion mixture, and is then used for a further function by being utilized as a sensor with which the ionization current is measured. This is advantageous because no space is needed in the combustion chamber for additional sensors. Ionization current measurement is based on the principle that ions are produced during the combustion of the fuel-air mixture. This ionization is the result of a variety of mechanisms which influence the typical profile of the ionization current and therefore provide information regarding specific parameters of the combustion process, etc. When a voltage is applied to the electrodes of the spark plug for ionization current measurement, electrons and ions present in the combustion chamber are moved in the corresponding direction of the electric field, thus creating a current which is carried by these charge carriers. This current represents the aforementioned ionization current. When the ionization current measurement method, known per se, is used with an inductive ignition apparatus which has an ignition coil device that operates according to the transformer principle and has a primary winding and a secondary winding, there exists, because of the relatively high secondary inductivity, the disadvantage that the spark duration of the spark plug is difficult to control; this can impede the measurement. In addition, because of the relatively high secondary inductivity in the ionization current path, it is possible to transfer only relatively low frequencies which, for example, are not sufficient for reliable knock detection.

### SUMMARY OF THE INVENTION

The ignition apparatus according to the present invention having the features recited in the principal claim has the advantage that as a result of a switch which short-circuits the primary winding of the ignition coil device for the duration of the ionization current measurement, the residual energy in the magnetic circuit of the ignition coil is dissipated on the primary side, i.e. is converted into heat energy and in that respect no longer drives the ignition spark, so that the latter is extinguished very quickly and reproducibly at the desired time. Short-circuiting of the primary side of the ignition coil device moreover shifts the limit frequency of the secondary side of the ignition coil considerably upward, so that any knock vibrations of the combustion engine that might occur can be observed in undamped fashion as an undesirable operating state, since the knock vibrations do not entail significant ionization current profiles.

It is particularly advantageous if the switch path of the switch has very low resistance in the closed state. The primary circuit of the ignition coil device thus has a much lower resistance than the secondary circuit, so that the ignition spark is quickly extinguished.

In particular, the switch can be configured as a field-effect transistor (FET) which possesses a low-resistance switch path at low flux voltages.

Lastly, it is advantageous if the measurement device has a control device which closes the switch preferably periodically at the desired spark termination, at least for the duration of the entire ionization current measurement. In the case of a field-effect transistor, this is accomplished by activating it accordingly.

### BRIEF DESCRIPTION OF THE DRAWINGS

The present invention will be explained below in more detail with reference to the Figures, in which:

FIG. 1 shows a circuit diagram of an inductive ignition apparatus having an ionization current measurement device according to a first exemplary embodiment; and

FIG. 2 shows a second exemplary embodiment of an inductive ignition apparatus having a measurement device for ascertaining the ionization current.

### DETAILED DESCRIPTION

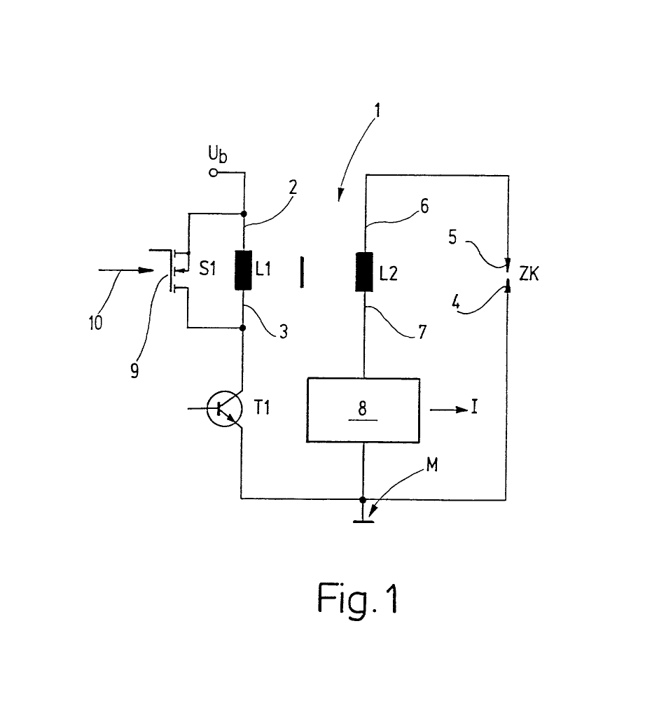

FIG. 1 shows an inductive ignition apparatus for a combustion engine (not depicted). The ignition apparatus has an ignition coil device 1 that comprises a primary winding L1 and a secondary winding L2, which are magnetically coupled to one another. The one winding end 2 of primary winding L1 is connected to the operating voltage, i.e. battery voltage U_{b} of a motor vehicle (not depicted) in which the combustion engine is installed. The other winding end 3 of primary winding L1 leads to the switch path of a transistor T1 which is activated by a control device (not depicted) in accordance with the desired ignition point. When transistor T1 is in the conductive state, winding end 3 can thus be connected to ground M (negative terminal of the battery delivering voltage U_{b}) via the collector-emitter path of transistor T1. A spark plug ZK, belonging to the combustion engine (not depicted), is connected with one of its electrodes 4 to ground M. The other electrode 5 of spark plug ZK is connected to one winding end 6 of secondary winding L2 of ignition coil device 1. The other winding end 7 of ignition coil device 1 leads to a measurement device 8 which measures an ionization current I. Measurement device 8 is also connected to ground M. The one winding end 2 of primary winding L1 of ignition coil device 1 is connected to one terminal of a switch S1. The other terminal of switch S1 leads to the other winding end 3 of primary winding L1. When switch S1 is closed, it is thus possible to short-circuit primary winding L1 of ignition coil device 1. Switch S1 is preferably configured as a field-effect transistor (FET), whose gate 9 can be activated by way of a control device (not depicted; indicated merely by an arrow 10) so that the aforementioned short-circuiting of primary winding L1 can be performed during desired time intervals. Corresponding activation of switch S1 thus makes it possible to short-circuit primary winding L1 of the carryover.

The manner of operation is thus as follows: Selected activation of the base of transistor T1 triggers a current flow in primary winding L1 of the ignition coil device, which results on the secondary side, i.e. in secondary winding L2, in the creation of a high voltage which causes triggering of an ignition spark at spark plug ZK. Once the combustion process has been initiated, spark plug ZK (functioning as a sensor) is then to be used to ascertain the ionization current in the combustion chamber of the combustion engine, so that conclusions can be drawn as to desired parameters. This is done by closing switch S1, causing the primary winding of the ignition coil device to be electrically short-circuited. The result is that the residual energy present in the magnetic circuit is dissipated, i.e. converted into heat energy. The ignition spark is thus extinguished in defined fashion and very quickly. At the same time, short-circuiting of the primary winding shifts the limit frequency of the secondary side of the ignition coil device considerably upward, so that the measurement can be made very accurately in the range relevant to knock vibrations, i.e. a particularly critical and undesirable operating state of the combustion engine can be sensed by measuring the ionization current. The result of the procedure according to the present invention, i.e. short-circuiting the primary winding for the entire duration of the ionization current measurement, is to achieve a spark duration at the spark plug which is so precise and short that ignition spark effects cannot in any circumstances impede subsequent measurement analysis or “mask” the measurement period. The short-circuiting according to the present invention also prevents the ignition system from decaying, i.e. the ionization current measurement cannot be influenced by decay effects, which can result in incorrect interpretations. As already mentioned, the increase in the limit frequency resulting from short-circuiting of the primary winding overcomes the considerable band limiting which exists with conventional systems and which has previously interfered with sensitivity in the detection of undesirable operating states, for example knock vibrations (3 to 20 kHz). The present invention thus improves the previously poor signal transfer properties of the secondary winding through which the ionization current flows.

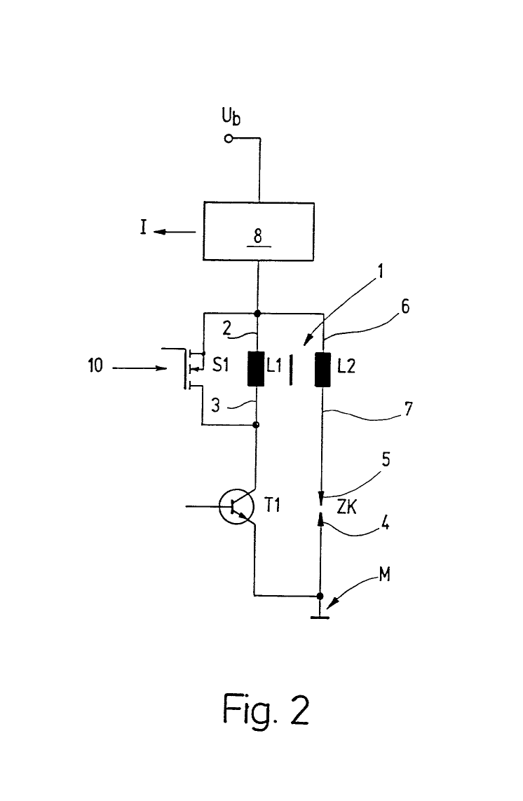

FIG. 2 shows a further exemplary embodiment of an inductive ignition apparatus having a measurement device for ascertaining an ionization current, identical parts having been given reference characters identical to those in FIG. 1. The comments applicable to the exemplary embodiment of FIG. 2 are the same as those regarding the exemplary embodiment of FIG. 1, so that only the differences between these two exemplary embodiments will be discussed below.

Whereas in the exemplary embodiment of FIG. 1, analysis device 8 for measuring the ionization current is arranged in the secondary circuit of ignition coil device 1, in the exemplary embodiment of FIG. 2 it is located in the primary circuit; specifically, the positive terminal of battery voltage U_{b} is connected to measurement device 8, and leads from there to the one winding end 2 of primary winding L1. The other winding end 3 of primary winding L1 is connected to the collector of transistor T1, whose emitter goes to ground M (negative terminal of battery voltage U_{b}). Electrode 4 of spark plug ZK is also connected to ground M. The other electrode 5 of spark plug ZK is connected to winding end 7 of secondary winding L2 of ignition coil device 1, and the other winding end 6 of secondary winding L2 is connected to winding end 2 of primary winding L1. Ignition coil device 1 is in that respect configured here as an autotransformer. Switch S1, once again preferably configured as a field-effect transistor (FET), is connected in parallel with primary winding L1, i.e. the one terminal of the switch path of switch S1 is connected to winding end 2, and the other terminal of switch S1 to winding end 3, of primary winding LI of ignition coil device 1.

The manner of operation is thus as follows: Activation of transistor T1 into its conductive state causes a current to flow through primary winding L1 of ignition coil device 1, generating on the secondary side, i.e. in secondary winding L2, a high voltage which triggers an ignition spark in spark plug ZK. Once ignition of the fuel-air mixture in the combustion chamber of the combustion engine (not depicted) has occurred, switch S1 is closed by the control device (arrow 10); in other words, primary winding L1 of ignition coil device 1 is short-circuited. This is yields the advantages already cited with respect to the exemplary embodiment of FIG. 1, so that an optimum ionization current measurement can be performed using measurement device 8.

1. An inductive ignition apparatus for a combustion engine, having a measurement device for ascertaining the ionization current at the spark plug of each cylinder, and having for each spark plug an ignition coil device which forms the ignition high voltage, operates on the transformer principle, and has a primary and a secondary winding, and through whose secondary winding the ionization current flows, characterized by a switch (S1) which short-circuits the primary winding (L1) for the duration of the ionization current measurement.

2. The ignition apparatus as defined in claim 1, characterized in that the switch path of the switch (S1) in the closed state has a very low resistance and exhibits low flux voltage.

3. The ignition apparatus as defined in one of the foregoing claims, characterized in that the switch (S1) is a field-effect transistor (FET).

4. The ignition apparatus as defined in one of the foregoing claims, characterized in that the measurement device (8) has a control device (arrow 10) which closes the switch (S1) preferably periodically, at least for the duration of the ionization current measurement.
